(19) United States
(12) Patent Application Publication
(10) Pub. No.: US 2025/0252859 A1
(43) Pub. Date: Aug. 7, 2025

(54) METHODS FOR AERIAL SEARCHES AND AIRCRAFT THEREFOR

(71) Applicant: HONEYWELL INTERNATIONAL INC., Charlotte, NC (US)

(72) Inventors: Saravana Venkatesh Narayana Samy, Madurai (IN); Anand Kutuva, Bangalore (IN); Gobinathan Baladhandapani, Madurai (IN)

(73) Assignee: HONEYWELL INTERNATIONAL INC., Charlotte, NC (US)

(21) Appl. No.: 18/631,695

(22) Filed: Apr. 10, 2024

(30) Foreign Application Priority Data
Feb. 1, 2024 (IN) 202411006750

(51) Int. Cl. G08G 5/00; G01C 21/00

(52) U.S. Cl. CPC G08G 5/74; G01C 21/3826; G01C 21/3852

(57) ABSTRACT

Methods and aircraft are provided for performing a search of a geographic region. The aircraft include a searchlight, onboard data sources, a display device, and a controller configured to, by one or more processors: generate a map of the geographic region that is segmented into sections, tag operating parameter data to the sections in response to illumination thereof with the searchlight, generate image data indicative of images of the sections, generate obstacle data indicative of obstacles in the sections based on the image data, a viewing perspective of the sections from the aircraft based on the operating parameter data, and orientations of the obstacles, generate visibility data indicative of visibility of the sections based on the operating parameter data and the obstacle data, assign display characteristics to the sections to produce a heatmap representative the visibility data, and display the heatmap on the display device.

### CROSS REFERENCE TO RELATED APPLICATION

This application claims priority to India Provisional Patent Application No. 20/241,1006750, filed Feb. 1, 2024, the entire content of which is incorporated by reference herein.

### TECHNICAL FIELD

The present invention generally relates to aerial searches, and more particularly relates to aircraft and methods for generating heatmaps representative of visibility of geographic regions during aerial searches.

### BACKGROUND

Search and Rescue (SAR) operations often utilize aircraft in aerial searches of geographic regions to find and assist individuals in real or potential distress, including activities like mountain rescue, ground search and rescue, and air-sea rescue. SAR operations often rely on visible confirmation and typically do not provide an effective, data-based means to determine the quality and completeness of the aerial search. This lack of data-based evaluation may result in certain areas being unintentionally omitted or repeatedly searched. In addition, visual confirmation of an area may be hindered by factors such as inadequate lighting, obstruction by obstacles, altitude, distance from the area, and viewing perspective.

Hence, there is a need for systems and methods for determining quality and completeness of an aerial search based on data rather than visual confirmation. There may also be a need for systems and methods for providing data-based recommendations for improving an aerial search. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a method is provided for performing an aerial search with an aircraft. The method may include generating, with a controller having one or more processors, a map of a geographic region that is segmented into a grid of sections, illuminating terrain within at least some of the sections of the grid with a beam of light generated by a searchlight system of the aircraft, wherein the at least some of the sections of the grid are designated as observed sections, and tagging operating parameter data to each of the observed sections in response to the terrain in each of the observed sections being illuminated with the beam of light. The operating parameter data is indicative of, at a time when each of the observed sections was illuminated, a position of the aircraft, an altitude of the aircraft, an angle of the beam of light relative to the aircraft, and an intensity of the beam of light. The method includes generating image data indicative of images of the terrain in each of the observed sections obtained with an imaging system of the aircraft in response to the terrain in each of the observed sections being illuminated with the beam of light, generating obstacle data indicative of obstacles identified in each of the observed sections based on the image data, a viewing perspective of each of the observed sections from the aircraft at the time when each of the observed sections was illuminated based on the operating parameter data, and orientations of each of the obstacles relative to the viewing perspective. The method includes generating visibility data indicative of visibility of each of the observed sections from the aircraft based on the operating parameter data and the obstacle data, assigning display characteristics to each of the observed sections on the map to produce a heatmap, wherein each of the display characteristics is representative of the visibility data associated with each of the observed sections, and displaying the heatmap on a display device of the aircraft.

In various embodiments, a method is provided for performing an aerial search of a geographic region to locate one or more people and/or objects. The method may include generating, with a controller having one or more processors, a map of the geographic region that is segmented into a grid of sections, and searching the geographic region with aircraft, wherein each of the aircraft individually observe at least some of the sections designated as observed sections. During the search, each of the aircraft, for each of the observed sections observed thereby: illuminate terrain within the observed section with a beam of light generated by a searchlight system of the corresponding one of the aircraft, tag operating parameter data to the observed section in response to the observed section being illuminated with the beam of light, wherein the operating parameter data is indicative of, at a time when the observed section was illuminated, a position of the corresponding one of the aircraft, an altitude of the corresponding one of the aircraft, an angle of the beam of light relative to the corresponding one of the aircraft, and an intensity of the beam of light, and generate image data indicative of images of each of the observed sections obtained with an imaging system of the corresponding one of the aircraft in response to each of the observed sections being illuminated with the beam of light. The method includes generating, with the controller, obstacle data indicative of obstacles identified in each of the observed sections based on the image data, a viewing perspective of each of the observed sections from the corresponding one of the aircraft at the time when each of the observed sections was illuminated based on the operating parameter data, and orientations of each of the obstacles relative to the viewing perspective, generating, with the controller, visibility data indicative of visibility of each of the observed sections from the corresponding one of the aircraft based on the operating parameter data and the obstacle data, and assigning, with the controller, display characteristics to each of the observed sections on the map to produce a heatmap, wherein each of the display characteristics is representative of the visibility data associated with each of the observed sections. The method includes receiving, by a mission coordinator system remote from the at least two aircraft, the heatmap from each of the aircraft, generating, by the mission coordinator system, a composite heatmap indicative of a combination of the heatmap received from each of the aircraft, determining, based on the composite heatmap, recommended operating parameters for each of the observed sections of the grid that are configured to promote visibility while observing each of the sections including recommended altitudes of the aircraft, distances of the aircraft from each of the observed sections, angles of the beam of light relative to the aircraft, a time of day, flight paths of the aircraft, and/or intensities of the beam of light, and displaying the composite heatmap and at least some of the recommended operating parameters assigned to each of the aircraft on display devices within the aircraft.

In various embodiments, an aircraft is provided that includes a searchlight system comprising a searchlight mounted on the aircraft, the searchlight configured to emit a beam of light and the searchlight system configured to controllably articulate the searchlight to modify a direction of the beam of light, one or more onboard data sources configured to determine a position of the aircraft, an altitude of the aircraft, an angle of the beam of light relative to the aircraft, and an intensity of the beam of light, a display device configured to generate a visual display, and a controller operably coupled to the searchlight system, the one or more onboard data sources, and the display device. The controller is configured to, by one or more processors: generate a map of a geographic region that is segmented into a grid of sections, wherein the sections of the grid are individually designated as observed sections in response to terrain within the sections being illuminated with the beam of light, tag operating parameter data to each of the observed sections in response to each of the observed sections being illuminated with the beam of light, wherein the operating parameter data is indicative of, at a time when each of the observed sections was illuminated, a position of the aircraft, an altitude of the aircraft, an angle of the beam of light relative to the aircraft, and the intensity of the beam of light; identifying obstacles in each of the sections of the grid, generate image data indicative of images of each of the observed sections obtained with an imaging system of the aircraft in response to each of the observed sections being illuminated with the beam of light, generate obstacle data indicative of obstacles identified in each of the observed sections based on the image data, a viewing perspective of each of the observed sections from the aircraft at the time when each of the observed sections was illuminated based on the operating parameter data, and orientations of each of the obstacles relative to the viewing perspective, generate visibility data indicative of visibility of each of the observed sections from the aircraft based on the operating parameter data and the obstacle data, assign display characteristics to each of the observed sections on the map to produce a heatmap, wherein each of the display characteristics is representative of the visibility data associated with each of the observed sections, and display the heatmap on the display device.

Furthermore, other desirable features and characteristics of the methods and aircraft will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents a mobile platform and components of a search efficiency system thereof in accordance with an embodiment;

FIG. 2 is a dataflow diagram illustrating operation of the search efficiency system of FIG. 1 in accordance with an embodiment;

FIG. 3 is an exemplary heatmap generated by the search efficiency system of FIG. 1 in accordance with an embodiment;

FIG. 4 is an exemplary terrain map of a geographic region corresponding to the heatmap of FIG. 3 in accordance with an embodiment;

FIG. 5 is a combination map including the heatmap of FIG. 3 overlaid on the terrain map of FIG. 4 in accordance with an embodiment;

FIG. 6 schematically represents an aerial search that is improved with use of recommended operating parameters for an aircraft in accordance with an embodiment;

FIG. 7 is a flowchart illustrating an exemplary method for preforming an aerial search with an aircraft in accordance with an embodiment; and

FIG. 8 is a flowchart illustrating an exemplary method for performing a coordinated aerial search in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for promoting efficiency of an aerial search of a geographic region by providing efficient, real-time visualizations and/or recommendations for a mobile platform. Broadly, the systems and methods provide a heatmap to a crew of the mobile platform representative of the efficiency of the aerial search of various sections of the geographic region. In some examples, the systems and methods provide recommended operating parameters for the mobile platform to improve the quality of the aerial search of each of the sections.

The mobile platform may be any type of vehicle, such as but not limited to various types of aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned helicopter and a manned airplane; however, as noted the systems and methods are not limited to such application.

For convenience, the systems and methods are described in reference to performance of a SAR operation that includes searching for an object, such as one or more people, a vehicle, or wreckage from a vehicle. However, the systems and methods are not limited to such applications, and may be applicable to other operations, other number and types of mobile platforms, and may or may not include a separate mission controller.

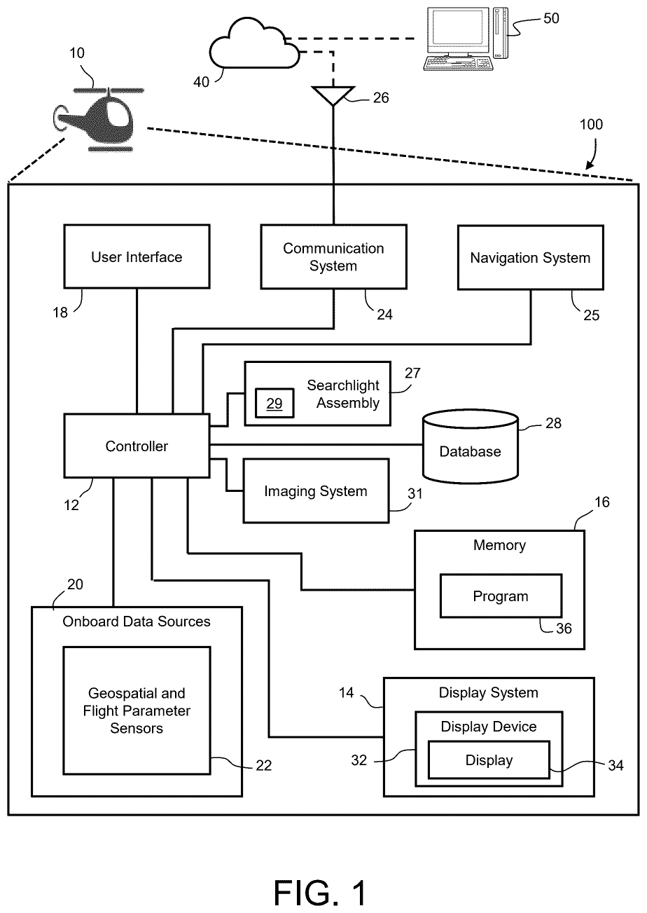

Referring now to FIG. 1, an aircraft 10, in this example a helicopter, and certain systems thereof are illustrated in accordance with an exemplary and non-limiting embodiment of the present disclosure. A search efficiency system 100 may be utilized onboard the aircraft 10 as described herein. As schematically depicted in FIG. 1, the system 100 includes and/or is functionally coupled to the following components or subsystems, each of which may assume the form of a single device or multiple interconnected devices, including, but not limited to, a controller 12 operationally coupled to: at least one display device 32, which may optionally be part of a larger on-board display system 14; computer-readable storage media or memory 16; an optional user interface 18, onboard data sources 20 including, for example, an array of geospatial and flight parameter sensors 22, a communication system 24, a navigation system 25, searchlight system 27, optionally, one or more databases 28, and an imaging system 31. The communication system 24 includes an antenna 26, which may wirelessly transmit data to and receive data from various external sources physically and/or geographically remote to the aircraft 10.

Although schematically illustrated in FIG. 1 as a single unit, the individual elements and components of the system 100 can be implemented in a distributed manner utilizing any practical number of physically distinct and operatively interconnected pieces of hardware or equipment. When the system 100 is utilized as described herein, the various components of the system 100 will typically all be located onboard the aircraft 10.

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the aircraft 10. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensors 22, perform logic, calculations, methods and/or algorithms, and generate data based on the logic, calculations, methods, and/or algorithms. Although only one controller 12 is shown in FIG. 1, embodiments of the aircraft 10 can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies one or more algorithms, to thereby perform the various process steps, tasks, calculations, and control/display functions described herein.

The controller 12 may exchange data with one or more external sources 40 to support operation of the system 100 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security.

In various embodiments, the communication system 24 is configured to support instantaneous (i.e., real time or current) communications between on-board systems, the controller 12, and the one or more external sources 40. The communication system 24 may incorporate one or more transmitters, receivers, and the supporting communications hardware and software required for components of the system 100 to communicate as described herein. In various embodiments, the communication system 24 may have additional communications not directly relied upon herein, such as bidirectional pilot-to-ATC (air traffic control) communications via a datalink, and any other suitable radio communication system that supports communications between the aircraft 10 and various external source(s).

The memory 16 can encompass any number and type of storage media suitable for storing computer-readable code or instructions, such as the program 36, as well as other data generally supporting the operation of the system 100. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

A source of information suitable for operating one or more systems of the aircraft 10 may be part of the system 100. In certain embodiments, the source is one or more databases 28 employed to receive and store map data, which may be updated on a periodic or iterative basis to ensure data timeliness. In various embodiments, the map data may include various terrain and manmade object locations and elevations and may be stored in the memory 16 or in the one or more databases 28, and referenced by the program 36. In various embodiments, these databases 28 may be available online and accessible remotely by a suitable wireless communication system, such as the communication system 24.

The geospatial and flight parameter sensors 22 supply various types of data and/or measurements to the controller 12. In various embodiments, the sensors 22 supplies, without limitation, one or more of: inertial reference system measurements providing a location, Flight Path Angle (FPA) measurements, airspeed data, groundspeed data, vertical speed data, vertical acceleration data, altitude data, attitude data including pitch and roll measurements, yaw data, data related to ownship weight, time/date information, heading information, data related to atmospheric conditions, flight path data, flight track data, radar altitude data, geometric altitude data, wind speed and direction data. Further, in certain embodiments of the system 100, the controller 12, and the other components of the system 100 may be included within or cooperate with any number and type of systems commonly deployed onboard aircraft including, for example, an FMS, an Attitude Heading Reference System (AHRS), an Instrument Landing System (ILS), and/or an Inertial Reference System (IRS).

With continued reference to FIG. 1, the display device 32 can include any number and type of image generating devices on which one or more avionic displays 34 may be produced. In various embodiments, the display device 32 may be affixed to the static structure of the aircraft 10 cockpit as, for example, a Head Down Display (HDD) or Head Up Display (HUD) unit. Alternatively, the display device 32 may assume the form of a movable display device (e.g., a pilot-worn display device) or a portable display device, such as an Electronic Flight Bag (EFB), a laptop, or a tablet computer carried into the aircraft 10 cockpit by a pilot.

At least one avionic display 34 is generated on display device 32 during operation of the system 100. The term “avionic display” as used herein is synonymous with the terms “aircraft-related display” and “cockpit display” and encompasses displays generated in textual, graphical, cartographical, and other formats. The system 100 can generate various types of lateral and vertical avionic displays 34 on which symbology, text annunciations, and other graphics pertaining to flight planning are presented for a pilot to view. The display device 32 is configured to continuously render at least one avionic display 34 showing a terrain environment at a current location of the aircraft 10. The avionic display 34 generated and controlled by the system 100 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

In various embodiments, a human-machine interface, such as a touch screen display, is implemented as an integration of the user interface 18 and the display device 32. Via various display and graphics systems processes, the controller 12 may command and control the touch screen display generating a variety of graphical user interface (GUI) objects or elements, for example, buttons, sliders, and the like, which are used to prompt a user to interact with the human-machine interface to provide user input, and to activate respective functions and provide user feedback, responsive to received user input at the GUI element.

The searchlight assembly 27 may include various components including a searchlight 29 configured to emit a beam of light that illuminates a light spot on an object on which the beam of light impinges (e.g., the ground), an actuation system comprising one or more actuators configured to control the movement and position of the searchlight 29 and thereby the direction of the beam of light, and a searchlight controller configured to control the actuation system based on preprogrammed instructions and/or user input. Orientation of the searchlight 29, via the actuation system, and therefore the direction of the beam of light and the location of the light spot may be manually controlled with an HMI device, such as a joystick, collective stick grip, multi-axis (way) hatch switch, etc., which may be a component of the user interface 18.

The navigation system 25 can provide navigation data associated with the aircraft's current position and flight direction (e.g., heading, course, track, etc.) to the controller 12. As such, the navigation system 25 can include, for example, an inertial navigation system, a satellite navigation system (e.g., Global Positioning System) receiver, VLF/OMEGA, Loran C, VOR/DME, DME/DME, IRS, aircraft attitude sensors, or the navigation information can come from a flight management system. The navigation data provided to the controller 12 can also include information about the aircraft's airspeed, ground speed, altitude (e.g., relative to sea level), pitch, and other important flight information. In any event, for this example embodiment, the navigation system 25 can include any suitable position and direction determination devices that are capable of providing the controller 12 with at least an aircraft's current position (e.g., in latitudinal and longitudinal form), the real-time direction (heading, course, track, etc.) of the aircraft in its flight path, and other important flight information (e.g., airspeed, altitude, pitch, attitude, etc.).

The imaging system 31 may include various components configured to capture images and/or video of an exterior of the aircraft 10. In some examples, the imaging system 31 includes at least one camera configured to capture images and/or video within a visual range of the electromagnetic spectrum.

Other systems onboard the aircraft 100 that are in communication with the controller 112 may include but are not limited to a flight control system, a traffic awareness and collision avoidance system, a fuel system, an electric system, an engine system, and a transponder system.

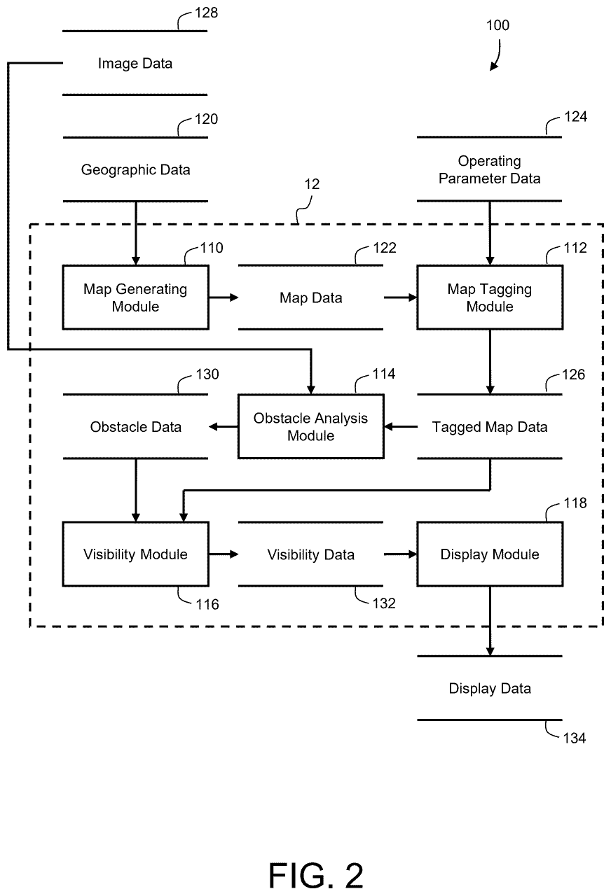

With reference to FIG. 2 and with continued reference to FIG. 1, a dataflow diagram illustrates elements of the system 100 of FIG. 1 in accordance with various embodiments. As can be appreciated, various embodiments of the system 100 according to the present disclosure may include any number of modules embedded within the controller 12 which may be combined and/or further partitioned to similarly implement systems and methods described herein. Furthermore, inputs to the system 100 may be received from other control modules (not shown) associated with the aircraft 10, and/or determined/modeled by other sub-modules (not shown) within the controller 12. Furthermore, the inputs might also be subjected to preprocessing, such as sub-sampling, noise-reduction, normalization, feature-extraction, missing data reduction, and the like. In various embodiments, the system 100 includes a map generating module 110, a map tagging module 112, an obstacle analysis module 114, a visibility module 116, and a display module 118.

In various embodiments, the map generating module 110 receives as input geographic data 120 received from, for example, the navigation system 25, the database 28, or the one or more external sources 40. The geographic data 120 includes various data indicating terrain information within a geographic region. In some examples, the geographic data 120 may include a geographic map of the geographic region. The map generating module 110 processes the geographic data 120 and generates a geographic map of the geographic regions that is segmented into a grid of sections. The map generating module 110 generates map data 122 that includes various data indicative of the segmented geographic map.

In various embodiments, the map tagging module 112 receives as input the map data 122 generated by the map generating module 110. In various embodiments, the map tagging module 112 receives as input operating parameter data 124 received from the onboard data sources 20, the navigation system 25, the database 28, and/or the one or more external sources 40. The operating parameter data 124 includes various data indicative of positions (e.g., longitude and latitude) of the aircraft 10, altitudes of the aircraft 10, angles (e.g., radials) of a beam of light relative to the aircraft 10, intensities of the beam of light, reflective intensities of terrain, reflection intensities of the terrain, and weather conditions within the geographic region.

In response to terrain within one of the sections (referred to as an observed section) of the segmented map being illuminated with the beam of light generated from the searchlight 29, the map tagging module 112 tags current values (i.e., obtained at a time when the observed section was illuminated) of the operating parameter data to the observed section. The map tagging module 112 generates tagged map data 126 that includes various data indicative of the segmented map having the corresponding operating parameter data tagged to each of the observed sections thereof.

In various embodiments, the obstacle analysis module 114 receives as input the tagged map data 126 generated by the map tagging module 112. In various embodiments, the obstacle analysis module 114 receives as input image data 128 received from an imaging system 31 of the aircraft 10. The image data 128 includes various data indicative of images of each of the observed sections obtained with the imaging system 31 of the aircraft 10 in response to terrain in each of the observed sections being illuminated with the beam of light. In some examples, the images are captured substantially simultaneously with the illumination of the terrain. In some examples, a camera of the imaging system may be configured to operate in a slave mode of the searchlight system such that the camera is continuously directed to capture images or video of terrain illuminated by the beam of light.

The obstacle analysis module 114 performs an analysis of the image data 128 to detect and/or identify obstacles (e.g., trees, buildings, etc.) located within and/or reducing visibility of each of the observed sections. The obstacle analysis module 114 may perform an analysis of the tagged map data 126 to determine a viewing perspective of each of the observed sections from the aircraft 10. The obstacle analysis module 114 may determine orientations of each of the obstacles relative to the viewing perspective. The obstacle analysis module 114 generates obstacle data 130 that includes various data indicative of the obstacles, viewing perspective, and orientations of the obstacles in each of the observed sections.

In various embodiments, the visibility module 116 receives as input the obstacle data 130 generated by the obstacle analysis module 114. In various embodiments, the visibility module 116 receives as input tagged map data 126 generated by the map tagging module 112. The visibility module 116 performs an analysis of the obstacle data 130 and the tagged map data 126 to determine how effective the search of the observed sections was from the aircraft 10. In some examples, the effectiveness may be estimated by determining a visibility of the terrain in each of the observed sections from the aircraft 10 at the time of illumination. The visibility module 116 generates visibility data 132 that includes various data indicative of how effective the search was of each of the observed sections.

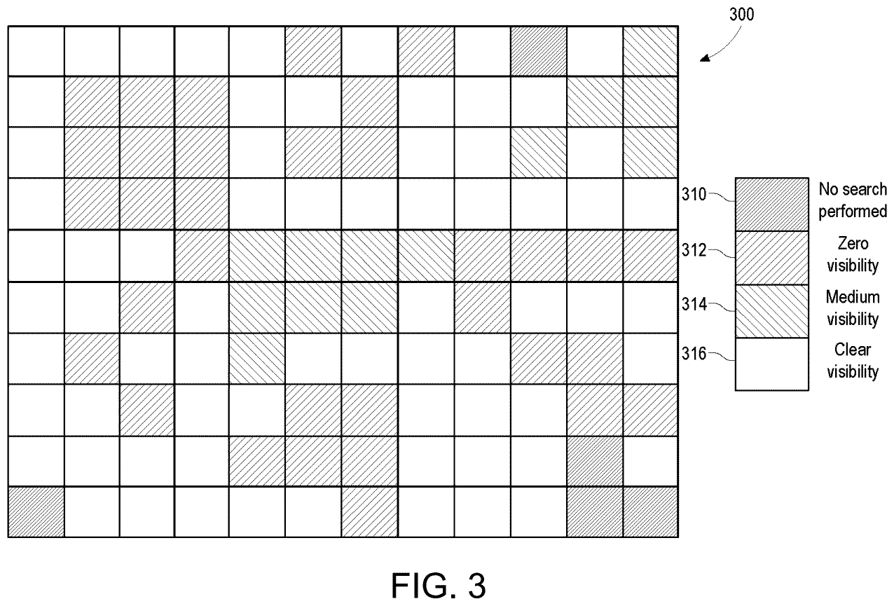

In some examples, the visibility module 116 may assign display characteristics to each of the observed sections on the segmented map to produce a heatmap. Nonlimiting examples of display characteristics may include colors, patterns, and other visual elements configured to be differentiated from each other. In such examples, each of the display characteristics is representative of the visibility associated with each of the observed sections. For example, FIG. 3 presents an exemplary heatmap 300 that includes a grid of 120 sections arranged in a 10×12 array. Each of the sections are filled with one of four colors (represented in FIG. 3 by shading) each corresponding to a level of visibility of the corresponding section. In this example, a first color 310 indicates that the terrain within the section was not observed by the aircraft 10 (i.e., not illuminated with the searchlight 29) during the search, a second color 312 indicates that the visibility of the terrain within the section was poor from the perspective of the aircraft 10 during the search, a third color 314 indicates that the visibility of the terrain within the section was medium (e.g., between poor and clear) from the perspective of the aircraft 10 during the search, and a fourth color 316 indicates that the visibility of the terrain within the section was clear from the perspective of the aircraft 10 during the search. The heatmap 300 allows for a crew of the aircraft 10 to more easily determine where to prioritize additional searching, such as in one or more of the sections having the first color 310, the second color 314, or the third color 316. As represented in FIG. 3, one or more of the observed sections (i.e., filled with the second color 312, the third color 314, and the fourth color 316) may include corresponding operating parameter data, such as the altitude (Alt), position (LAT/LON), and angle (Angle) of the beam of light when the specific observed section was illuminated.

In various embodiments, the display module 118 receives as input the visibility data 132 generated by the visibility module 116. The display module 118 generates display data 134 that includes various data readable by the display system 14 and configured to display on the display device 32 the SAR effectiveness data 118 or a representation thereof. The display module 118 may transmit the display data 134 to the display system 14.

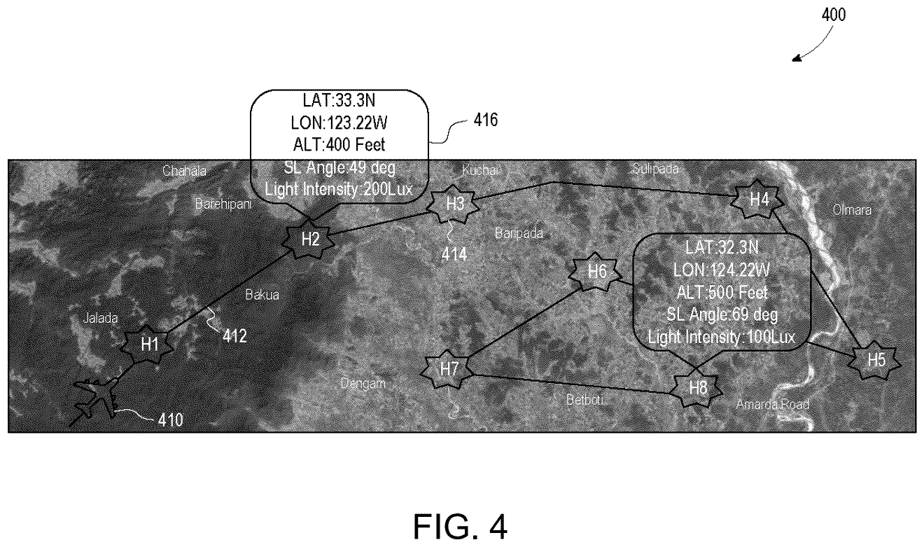

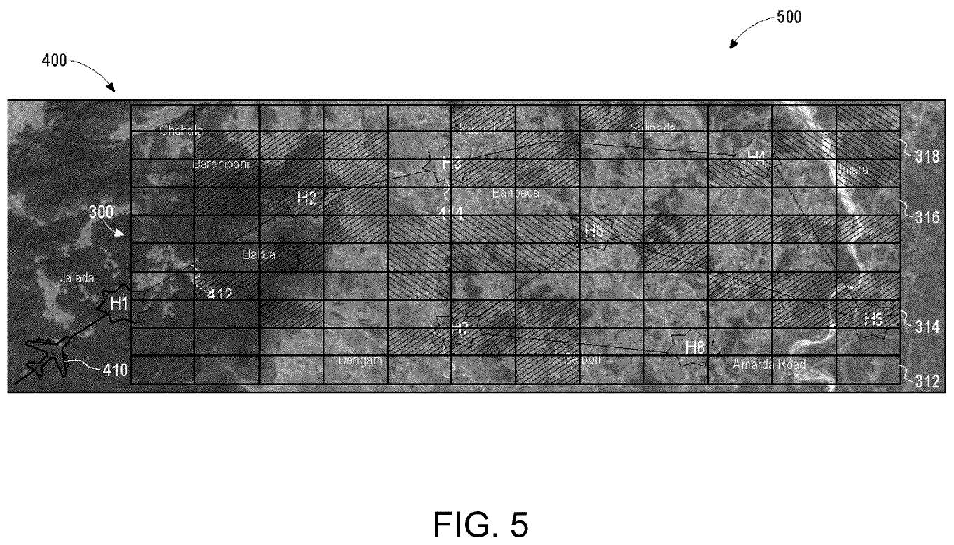

In various examples, the visibility data 132 may include a heatmap, such as the exemplary heatmap 300 of FIG. 3, and the heatmap may be displayed on the display device 32. In some examples, the heatmap may be overlaid on a terrain map of the geographic region on the display device. In such examples, the heatmap may be partially transparent to provide for the terrain map to be viewable therebelow. This arrangement may promote readability for the crew of the aircraft 10 and further promote improvements to the quality of the search. As an example, FIG. 4 presents an exemplary terrain map 400 that includes representations of terrain within the geographic region (e.g., trees, rivers, etc.). In this example, the terrain map 400 includes an aircraft icon 410 representing the position and flight direction of the aircraft 10, a flight path represented by a line 412, and various points of interest 414 (labeled H1-H8) along the flight path. In some examples, a user may select one or more of the points of interest to observe a list 416 of operating parameters assigned thereto. FIG. 5 presents the heatmap 300 of FIG. 3 overlaid on the terrain map 400 of FIG. 4 to define a combination map 500.

In various embodiments, the visibility module 116 or another module may determine, based on the visibility data 132, recommended operating parameters of the aircraft 10 configured to promote visibility of the observed sections while performing an additional search observing each of the observed sections including recommended altitudes of the aircraft 10, distances of the aircraft 10 from each of the observed sections, angles of the beam of light, a time of day, flight paths of the aircraft 10, and/or intensities of the beam of light. In some examples, the display data 134 may be configured to instruct the display device 32 to display some or all of the recommended operating parameters thereon.

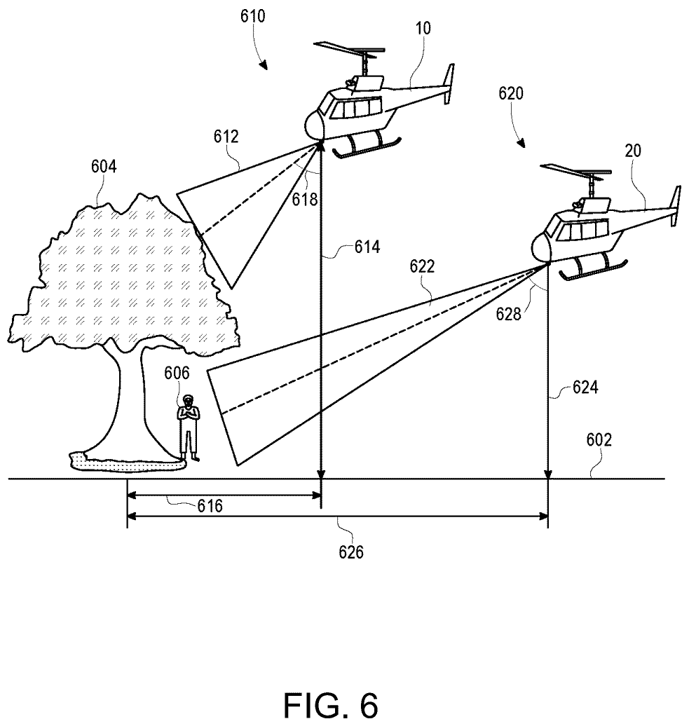

FIG. 6 presents an example of a search being improved by use of recommended operating parameters. In a first search 610 of a section, the aircraft 10 is at a first altitude 614 (relative to ground 602), a first distance 616 from the sector or observed portion thereof, and emits a first beam of light 612 at a first angle 618 toward terrain of a sector. As represented, the first beam of light 612 emitted from the aircraft 10 is obstructed by a tree 604. In this example, a generated heatmap may have labeled the section as having poor visibility during or after the first search 610. As such, a second search 620 of the section is performed with the aircraft 10 at a second altitude 624, a second distance 626 from the sector or observed portion thereof, and a second beam of light 622 emitted at a second angle 628 toward the terrain of the sector, all of which were based on the recommended operating parameters. With these adjustments, the second beam of light 622 is directed below the tree 604 and an individual 606 therebelow is viewable.

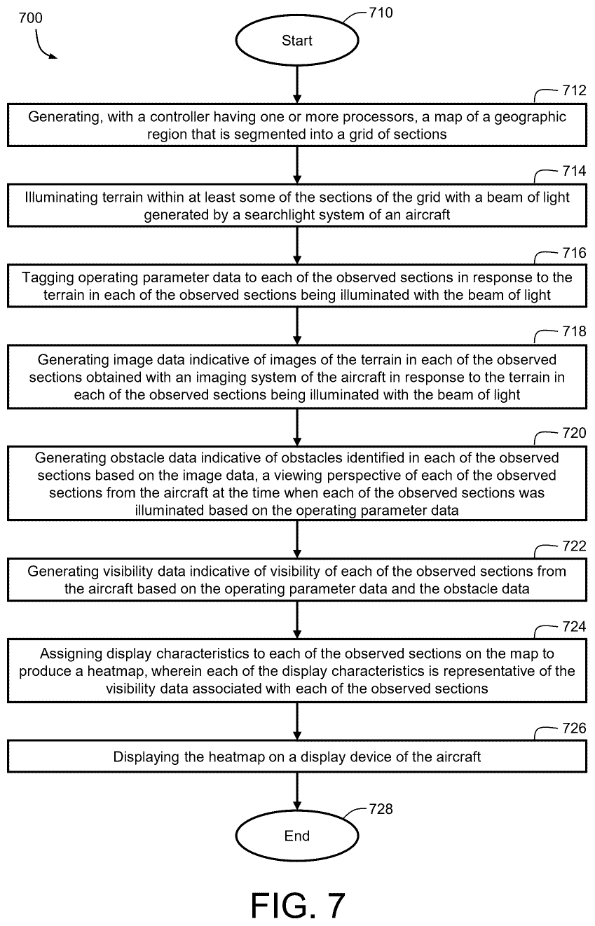

The systems disclosed herein, including the system 100, provide for methods of evaluating and improving an aerial search of a geographic region and, optionally, recommending operating parameters for one or more aircraft configured to improve the quality and/or effectiveness of the aerial search. For example, FIG. 7 is a flowchart illustrating an exemplary method 700. The method 700 may start at 710.

At 712, the method 700 may include generating, with a controller having one or more processors, a map of a geographic region that is segmented into a grid of sections.

At 714, the method 700 may include illuminating terrain within at least some of the sections of the grid with a beam of light generated by a searchlight system of the aircraft, wherein the at least some of the sections of the grid are designated as observed sections.

At 716, the method 700 may include tagging operating parameter data to each of the observed sections in response to the terrain in each of the observed sections being illuminated with the beam of light, wherein the operating parameter data is indicative of, at a time when each of the observed sections was illuminated, a position of the aircraft, an altitude of the aircraft, an angle of the beam of light relative to the aircraft, and an intensity of the beam of light.

At 718, the method 700 may include generating image data indicative of images of the terrain in each of the observed sections obtained with an imaging system of the aircraft in response to the terrain in each of the observed sections being illuminated with the beam of light.

At 720, the method 700 may include generating obstacle data indicative of obstacles identified in each of the observed sections based on the image data, a viewing perspective of each of the observed sections from the aircraft at the time when each of the observed sections was illuminated based on the operating parameter data, and orientations of each of the obstacles relative to the viewing perspective. In some examples, the images may be processed with an image recognition software to identify the obstacles in each of the observed sections.

At 722, the method 700 may include generating visibility data indicative of visibility of each of the observed sections from the aircraft based on the operating parameter data and the obstacle data. In some examples, the operating parameter data may include additional information and such information may be considered when generating the visibility data. For example, the visibility data may be generated with consideration of environmental conditions within the geographic region, such as the weather conditions. As another example, the visibility data may be generated with consideration of a reflection intensity of terrain in each of the observed sections. In some examples, the reflection intensity may be determined by analysis of the images or by measurement with a lux meter.

At 724, the method 700 may include assigning display characteristics to each of the observed sections on the map to produce a heatmap, wherein each of the display characteristics is representative of the visibility data associated with each of the observed sections. In some embodiments, the method 700 may include overlaying the heatmap on a terrain map of the geographic region with the heatmap being partially transparent to provide for the terrain map to be viewable therebelow.

At 726, the method 700 may include displaying the heatmap (with or without the terrain map therebelow) on a display device of the aircraft.

In some examples, the method 700 may include determining, based on the visibility data, recommended operating parameters configured to promote visibility of the observed sections while observing each of the observed sections including recommended altitudes of the aircraft, distances of the aircraft from each of the observed sections, angles of the beam of light, a time of day, flight paths of the aircraft, and/or intensities of the beam of light. In such examples, the recommended operating parameters may be displayed on the display device. In some examples, the recommended operating parameters may be distributed to one or more additional vehicles and/or remote systems.

In some examples, the visibility data and/or the recommended operating parameters may be produced in during the search, and the search parameters and/or operating parameters of the aircraft may be modified automatically or manually in real-time to improve the search. For example, the intensity of the beam of light may be automatically adjusted while the beam of light is illuminating a first section of the observed sections based on the visibility data for the first section. As another example, the crew of the aircraft may adjust the position of the aircraft, the altitude of the aircraft, and/or the angle of the beam of light based on the recommended operating parameters determined in real-time while searching a section.

The method 700 may end at 728.

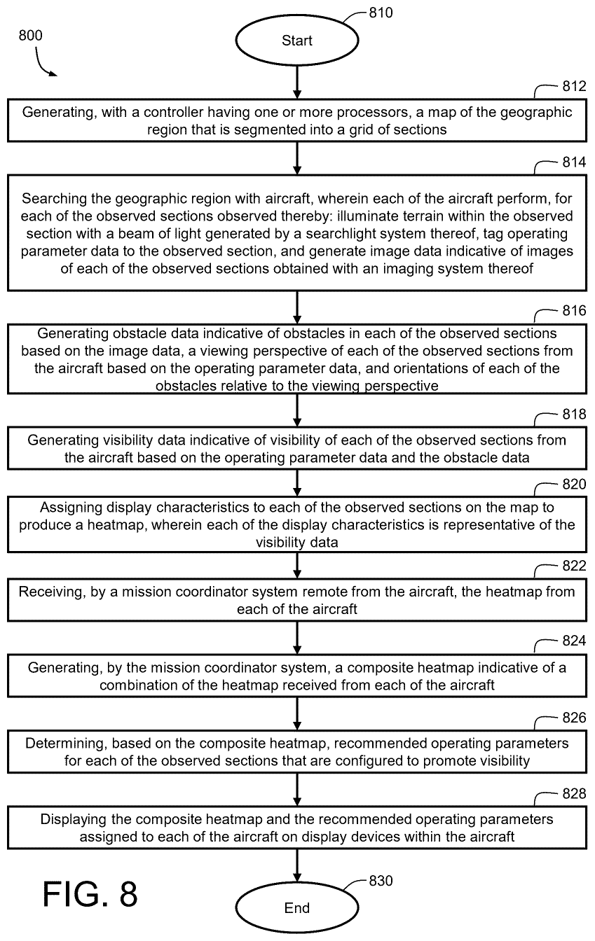

In various embodiments, the systems and methods disclosed herein may be used in a coordinated search of a geographic region by multiple aircraft, optionally directed by a mission coordinator. For example, FIG. 8 is a flowchart illustrating an exemplary method 800 for performing a search and rescue (SAR) mission of a geographic region to locate one or more people and/or objects. Various steps of the method 800 may be performed by one or more of the aircraft, by the mission controller system, or both. The method 800 may start at 810.

At 812, the method 800 may include generating, with a controller having one or more processors, a map of the geographic region that is segmented into a grid of sections.

At 814, the method 800 may include searching the geographic region with aircraft. Each of the aircraft may individually observe at least some of the sections designated as observed sections. During the search, each of the aircraft, for each of the observed sections observed thereby: illuminate terrain within the observed section with a beam of light generated by a searchlight system of the corresponding one of the aircraft, tag operating parameter data to the observed section in response to the observed section being illuminated with the beam of light, and generate image data indicative of images of each of the observed sections obtained with an imaging system of the corresponding one of the aircraft in response to each of the observed sections being illuminated with the beam of light. The operating parameter data may be indicative of, at a time when the observed section was illuminated, a position of the corresponding one of the aircraft, an altitude of the corresponding one of the aircraft, an angle of the beam of light relative to the corresponding one of the aircraft, and an intensity of the beam of light.

At 816, the method 800 may include generating, with the controller, obstacle data indicative of obstacles identified in each of the observed sections based on the image data, a viewing perspective of each of the observed sections from the corresponding one of the aircraft at the time when each of the observed sections was illuminated based on the operating parameter data, and orientations of each of the obstacles relative to the viewing perspective.

At 818, the method 800 may include generating, with the controller, visibility data indicative of visibility of each of the observed sections from the corresponding one of the aircraft based on the operating parameter data and the obstacle data.

At 820, the method 800 may include assigning, with the controller, display characteristics to each of the observed sections on the map to produce a heatmap. Each of the display characteristics may be representative of the visibility data associated with each of the observed sections.

At 822, the method 800 may include receiving, by a mission coordinator system remote from the aircraft, the heatmap from each of the aircraft.

At 824, the method 800 may include generating, by the mission coordinator system, a composite heatmap indicative of a combination of the heatmap received from each of the aircraft. Various methods may be used to produce the composite heatmap. In some examples, the composite heatmap may include, for each sector thereof, a display characteristic assigned based on the operating parameter data from one of the aircraft that observed the sector that is determined to have provided the best visibility during the search. For example, if a first aircraft observed the sector from a first side with medium visibility and a second aircraft observed the sector from an opposite, second side with poor visibility, the first aircraft may be determined to have performed the best search of the section, and the display characteristic assigned may represent medium visibility. In some examples, the composite heatmap may include, for each sector thereof, a display characteristic assigned based on a combination of the operating parameter data from each of the aircraft that observed the sector. For example, if a first aircraft observed the sector from a first side with medium visibility and a second aircraft observed the sector from an opposite, second side with medium visibility, the combination of the two observations of the sector may be determined to be substantially equal to a single observation with clear visibility.

At 826, the method 800 may include determining, based on the composite heatmap, recommended operating parameters for each of the observed sections of the grid that are configured to promote visibility while observing each of the sections. The recommended operating parameters may include recommended altitudes of the aircraft, distances of the aircraft from each of the observed sections, angles of the beam of light relative to the aircraft, a time of day, flight paths of the aircraft, and/or intensities of the beam of light.

At 828, the method 800 may include displaying the composite heatmap and at least some of the recommended operating parameters assigned to each of the aircraft on display devices within the aircraft.

The method 800 may end at 830.

The systems and methods disclosed herein provide various benefits over certain existing systems and methods. For example, determining the visibility during the search, generating the heatmap, and, optionally, providing recommended operating parameters, the systems and methods disclosed herein provide a means for evaluating and promoting the efficiency of an aerial search of a geographic region. In some examples, the systems and methods m promote ease of a crew or an operator of a mobile platform (or a mission coordinator) in determining which areas of the geographic region need additional searching.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for performing an aerial search with an aircraft, comprising:
generating, with a controller having one or more processors, a map of a geographic region that is segmented into a grid of sections;
illuminating terrain within at least some of the sections of the grid with a beam of light generated by a searchlight system of the aircraft, wherein the at least some of the sections of the grid are designated as observed sections;
tagging, with the controller, operating parameter data to each of the observed sections in response to the terrain in each of the observed sections being illuminated with the beam of light, wherein the operating parameter data is indicative of, at a time when each of the observed sections was illuminated, a position of the aircraft, an altitude of the aircraft, an angle of the beam of light relative to the aircraft, and an intensity of the beam of light;
generating image data indicative of images of the terrain in each of the observed sections obtained with an imaging system of the aircraft in response to the terrain in each of the observed sections being illuminated with the beam of light;
generating, with the controller, obstacle data indicative of obstacles identified in each of the observed sections based on the image data, a viewing perspective of each of the observed sections from the aircraft at the time when each of the observed sections was illuminated based on the operating parameter data, and orientations of each of the obstacles relative to the viewing perspective;
generating, with the controller, visibility data indicative of visibility of each of the observed sections from the aircraft based on the operating parameter data and the obstacle data;
assigning, with the controller, display characteristics to each of the observed sections on the map to produce a heatmap, wherein each of the display characteristics is representative of the visibility data associated with each of the observed sections; and
displaying the heatmap on a display device of the aircraft.

2. The method of claim 1, further comprising overlaying the heatmap on a terrain map of the geographic region on the display device, wherein the heatmap is partially transparent to provide for the terrain map to be viewable therebelow.

3. The method of claim 1, further comprising:
determining, with the controller, recommended operating parameters based on the visibility data, wherein the recommended operating parameters are configured to promote visibility of the observed sections while observing each of the observed sections including recommended altitudes of the aircraft, distances of the aircraft from each of the observed sections, angles of the beam of light, a time of day, flight paths of the aircraft, and/or intensities of the beam of light; and
displaying the recommended operating parameters on the display device.

4. The method of claim 3, further comprising distributing the recommended operating parameters to one or more additional vehicles and/or remote systems.

5. The method of claim 1, wherein generating the obstacle data includes processing, with the controller, the images with an image recognition software to identify the obstacles in each of the observed sections.

6. The method of claim 1, further comprising automatically adjusting, with the controller, the intensity of the beam of light while the beam of light is illuminating a first section of the observed sections based on the visibility data for the first section.

7. The method of claim 1, wherein generating the visibility data includes consideration of environmental conditions within the geographic region.

8. The method of claim 1, further comprising determining a reflection intensity of terrain in each of the observed sections, wherein generating the visibility data includes consideration of the reflection intensity of each of the observed sections.

9. The method of claim 1, wherein the aircraft is participating in a search and rescue (SAR) mission intended to locate one or more people and/or objects within the geographic region, wherein the visibility data is indicative of a likelihood of observation of the one or more people and/or objects within the observed sections if the one or more people and/or objects were located in the observed sections based on the visibility of the observed sections from the aircraft.

10. A method for performing an aerial search of a geographic region to locate one or more people and/or objects, comprising:
generating, with a controller having one or more processors, a map of the geographic region that is segmented into a grid of sections;
searching the geographic region with aircraft, wherein each of the aircraft individually observe at least some of the sections designated as observed sections, wherein each of the aircraft perform, for each of the observed sections observed thereby:
illuminate terrain within the observed section with a beam of light generated by a searchlight system of the corresponding one of the aircraft;
tag operating parameter data to the observed section in response to the observed section being illuminated with the beam of light, wherein the operating parameter data is indicative of, at a time when the observed section was illuminated, a position of the corresponding one of the aircraft, an altitude of the corresponding one of the aircraft, an angle of the beam of light relative to the corresponding one of the aircraft, and an intensity of the beam of light;
generate image data indicative of images of each of the observed sections obtained with an imaging system of the corresponding one of the aircraft in response to each of the observed sections being illuminated with the beam of light;
generating, with the controller, obstacle data indicative of obstacles identified in each of the observed sections based on the image data, a viewing perspective of each of the observed sections from the corresponding one of the aircraft at the time when each of the observed sections was illuminated based on the operating parameter data, and orientations of each of the obstacles relative to the viewing perspective;
generating, with the controller, visibility data indicative of visibility of each of the observed sections from the corresponding one of the aircraft based on the operating parameter data and the obstacle data;
assigning, with the controller, display characteristics to each of the observed sections on the map to produce a heatmap, wherein each of the display characteristics is representative of the visibility data associated with each of the observed sections;
receiving, by a mission coordinator system remote from the at least two aircraft, the heatmap from each of the aircraft;
generating, by the mission coordinator system, a composite heatmap indicative of a combination of the heatmap received from each of the aircraft;
determining, based on the composite heatmap, recommended operating parameters for each of the observed sections of the grid that are configured to promote visibility while observing each of the sections including recommended altitudes of the aircraft, distances of the aircraft from each of the observed sections, angles of the beam of light relative to the aircraft, a time of day, flight paths of the aircraft, and/or intensities of the beam of light; and
displaying the composite heatmap and at least some of the recommended operating parameters assigned to each of the aircraft on display devices within the aircraft.

11. The method of claim 10, further comprising overlaying the composite heatmap on a terrain map of the geographic region on the display devices within the aircraft, wherein the composite heatmap is partially transparent to provide for the terrain map to be viewable therebelow.

12. The method of claim 10, further comprising automatically adjusting the intensity of the beam of light generated by the searchlight system of a first of the aircraft while the beam of light is illuminating a first section of the observed sections of the grid based on the visibility data for the first section.

13. The method of claim 10, further comprising determining a reflection intensity of terrain in each of the observed sections, wherein generating the visibility data includes consideration of the reflection intensity of each of the observed sections.

14. An aircraft, comprising:
a searchlight system comprising a searchlight mounted on the aircraft, the searchlight configured to emit a beam of light and the searchlight system configured to controllably articulate the searchlight to modify a direction of the beam of light;
one or more onboard data sources configured to determine a position of the aircraft, an altitude of the aircraft, an angle of the beam of light relative to the aircraft, and an intensity of the beam of light;
a display device configured to generate a visual display;
a controller operably coupled to the searchlight system, the one or more onboard data sources, and the display device, the controller configured to, by one or more processors:
generate a map of a geographic region that is segmented into a grid of sections, wherein the sections of the grid are individually designated as observed sections in response to terrain within the sections being illuminated with the beam of light;
tag operating parameter data to each of the observed sections in response to each of the observed sections being illuminated with the beam of light, wherein the operating parameter data is indicative of, at a time when each of the observed sections was illuminated, a position of the aircraft, an altitude of the aircraft, an angle of the beam of light relative to the aircraft, and the intensity of the beam of light; identifying obstacles in each of the sections of the grid;
generate image data indicative of images of each of the observed sections obtained with an imaging system of the aircraft in response to each of the observed sections being illuminated with the beam of light;
generate obstacle data indicative of obstacles identified in each of the observed sections based on the image data, a viewing perspective of each of the observed sections from the aircraft at the time when each of the observed sections was illuminated based on the operating parameter data, and orientations of each of the obstacles relative to the viewing perspective;
generate visibility data indicative of visibility of each of the observed sections from the aircraft based on the operating parameter data and the obstacle data;
assign display characteristics to each of the observed sections on the map to produce a heatmap, wherein each of the display characteristics is representative of the visibility data associated with each of the observed sections; and
display the heatmap on the display device.

15. The aircraft of claim 14, wherein the controller is configured to, by the one or more processors, overlay the heatmap on a terrain map of the geographic region on the display device, wherein the heatmap is partially transparent to provide for the terrain map to be viewable therebelow.

16. The aircraft of claim 14, wherein the controller is configured to, by the one or more processors:
determine, based on the visibility data, recommended operating parameters configured to promote visibility of the observed sections while observing each of the observed sections including recommended altitudes of the aircraft, distances of the aircraft from each of the observed sections, angles of the searchlight, a time of day, flight paths of the aircraft, and/or intensities of the beam of light; and
display the recommended operating parameters on the display device.

17. The aircraft of claim 14, wherein the controller is configured to, by the one or more processors, generate the obstacle data by processing the images with an image recognition software to identify the obstacles in each of the observed sections.

18. The aircraft of claim 14, wherein the controller is configured to, by the one or more processors, automatically adjust the intensity of the beam of light generated by the searchlight system while the beam of light is illuminating a first section of the sections of the grid based on the visibility data for the first section.

19. The aircraft of claim 14, wherein the controller is configured to, by the one or more processors, generate the visibility data with consideration of environmental conditions within the geographic region.

20. The aircraft of claim 14, wherein the controller is configured to, by the one or more processors, determine a reflection intensity of terrain in each of the observed sections, wherein generating the visibility data includes consideration of the reflection intensity of each of the observed sections.
